(19) United States
(12) Patent Application Publication
(10) Pub. No.: US 2014/0181147 A1
(43) Pub. Date: Jun. 26, 2014

(54) DNA MATCHING

(71) Applicant: Forensic Science Service Limited, Birmingham (GB)

(72) Inventor: Martin BILL, Birmingham (GB)

(73) Assignee: Forensic Science Service Limited, Birmingham (GB)

(21) Appl. No.: 14/047,525

(22) Filed: Oct. 7, 2013

Related U.S. Application Data
(63) Continuation of application No. 12/161,758, filed on Jun. 3, 2010, now abandoned.

(30) Foreign Application Priority Data
Feb. 2, 2006 (GB) 0602106.7

(51) Int. Cl. G06F 19/18; G06F 17/30

(52) U.S. Cl. CPC G06F 19/18; G06F 17/30542
USPC 707/780

(57) ABSTRACT

A method of searching a computer database containing a plurality of stored DNA profiles is provided. The method involves generating a search profile formed of two or more allele identities for each of one or more loci, at least one of the allele identities having a limited range of values, with the search profile being compared against the one or more stored DNA profiles from a database to establish matches between the search and stored profile.

This application is a Continuation Application of U.S. Ser. No. 12/161,758 filed 3 Jun. 2010, which is a National Stage Application of PCT/GB2007/000365, filed 2 Feb. 2007, which claims benefit of Serial No. 0602106.7, filed 2 Feb. 2006 in Great Britain and which applications are incorporated herein by reference. To the extent appropriate, a claim of priority is made to each of the above disclosed applications.

This invention concerns improvements in and relating to DNA matching, particularly, but not exclusively between a first DNA profile and one or more stored profiles held in a database.

Existing approaches to the matching of a DNA profile to stored profiles are limited in their versatility. It is amongst the potential aims of the present invention to provide a more discriminating, whilst fully encompassing, approach to DNA matching.

According to a first aspect of the invention we provide a method of searching a computer database containing a plurality of stored DNA profiles, the method comprising

generating a search profile, the search profile being formed of two or more allele identities for each of one or more loci, the allele identities having one of a value or a limited range of values or any value, wherein at least one of the allele identities has a limited range of values;

accessing one or more of the stored DNA profiles from the computer database; the stored DNA profiles having two or more allele identities for each of one or more loci, the allele identities having one of a value or a range of values or any value;

comparing, using a computer implemented method, the search profile against the one or more stored DNA profiles;

establishing that the search profile matches a stored DNA profile when, in respect of a locus, the allele identities of the search profile correspond to or fall within the values for the allele identities for that locus of that stored DNA profile;

outputting a data set, the data set indicating those of the stored DNA profiles established as matching the search profile.

The first aspect of the invention may include any of the features, options or possibilities set out elsewhere in this document.

According to a second aspect of the invention we provide a method of searching a database containing a plurality of stored DNA profiles, the method comprising

generating a search profile, the search profile being formed of two or more allele identities for each of one or more loci, the allele identities having one of a value or a range of values or any value, wherein at least one of the allele identities has a range of values;

accessing one or more of the stored DNA profiles from the database, the stored DNA profiles having two or more allele identities for each of one or more loci, the allele identities having one of a value or a range of values or any value;

comparing the search profile against the one or more stored DNA profiles;

establishing that the search profile matches a stored DNA profile when, in respect of a locus, the allele identities of the search profile correspond to or fall within the values for the allele identities for that locus of that stored DNA profile;

outputting a data set, the data set indicating those of the stored DNA profiles established as matching the search profile.

The second aspect of the invention may include any of the features, options or possibilities set out elsewhere in this document, including the following.

The database may be a computer database. The method may include comparing, using a computer implemented method, the search profile against the one or more stored DNA profiles.

According to a third aspect of the invention we provide a method of searching a database containing a plurality of stored profiles, the method comprising

generating a search profile, the search profile being formed of two or more identities for each of one or more targets, the identities having one of a value or a range of values or any value, wherein at least one of the identities has a range of values;

accessing one or more of the stored profiles from the database, the stored profiles having two or more identities for each of one or more targets, the identities having one of a value or a range of values or any value;

comparing the search profile against the one or more stored profiles;

establishing that the search profile matches a stored profile when, in respect of a target, the identities of the search profile correspond to or fall within the values for the identities for that target of that stored profile;

outputting a data set, the data set indicating those of the stored profiles established as matching the search profile.

The third aspect of the invention may include any of the features, options or possibilities set out elsewhere in this document, including the following.

The database may be a computer database. The method may include comparing, using a computer implemented method, the search profile against the one or more stored DNA profiles. The stored profiles may be stored DNA profiles. The search profile identities may be allele identities. The search profile targets may be loci. The stored DNA profile identities may be allele identities. The stored DNA profile targets may be loci.

The first and/or second and/or third aspects of the present invention may provide from amongst the following features.

The database may contain at least 10,000 stored profiles, more preferably contains at least 100,000 stored profiles and ideally contains at least 1,000,000 stored profiles.

The database may include stored profiles which have two or more identities for each of the set of loci used in the database. The database may included stored profiles which potentially have two or more identities for each of at least 10 loci. The database may include stored profiles which lack one or more of the identities for one or more loci. The database may include stored profiles which have been assigned an indication of any value being possible or have been assigned a wildcard function for one or more identities of one or more loci.

The search profile may comprise two or more alternative single profiles. The alternative single profiles may be separately compared against the one or more stored profiles. Preferably matches for a search profile which comprises two or more alternative single profiles are outputted as a single data set. Preferably the single profiles include two or more, preferably allele, identities for each of one or more targets, preferably loci. Preferably the single profiles have identities having one of a value or any value. Preferably the presence of an identity which has a range of values within the search profile is provided by the two or more different values used for an identity between different single profiles.

The search profile may be a single profile. The single profile may include at least one of the allele identities having a limited range of values.

The two or more identities for a target, preferably loci, may have the same or different values. The value of one or more of the identities, preferably all having a value, may be an integer. The one or more identities having any value may be provided by a wildcard function. The value of one or more of the identities, preferably all having a value or limited range of values, may be expressed in terms of an allele size. The value of one or more of the identities, preferably all having a value or limited range of values, may be expressed in terms of an allele designation. The identities having a limited range of values may have a range of 5 allele designations or less.

A plurality of loci may be included in the search profile. The search profile may include loci from one or more of D3, VWA, D16, D2, D8, D21, D18, D19, THO or FGA

The method may establish that the search profile matches a stored DNA profile when, in respect of more than one locus, the allele identities of the search profile correspond to or fall within the values for the allele identities for those loci of that stored DNA profile.

The outputted data set may provide a list of stored DNA profiles established as matching the search profile. The outputted data set may provide a ranked list, with the rank being provided according to a likelihood of the match.

The method may include using the outputted data set to indicate a person and/or item and/or location which was the source of a DNA profile matching the search profile.

Partial or complete DNA profiles may be obtained in a variety of ways and from a variety of sources. They are of particular interest in forensic science. An important part of the consideration of a DNA profile is to compare it with one or more other profiles. The comparison can be used to establish that there is a match, or a likelihood of a match, between the two.

The present invention provides a method for search a DNA profile database in a way which provides a balanced approach to capturing potential matches of interest, whilst still providing significant discriminating power so as to avoid capturing irrelevant potential matches. The present invention may also allow new questions to be asked in the search of the database search, for example “find me any potential offspring from these alleged parents”. The invention is suitable for use in conjunction with a database featuring DNA profiles obtained by the analysis of DNA containing samples from individuals, mixtures, crime scenes and items. The invention is suitable for use with a database such as The National DNA Database (UK Registered Trade Mark).

The present invention allows a constrained range of values to be set for one or more of the allele identities involved in the search profile. Constraining the range ensures that all realistically possible values for that identity are consider and so no potentially relevant matches are inadvertently discarded. At the same time, the constraining of the range ensures that unrealistic values for the identities are not considered. Doing so could potentially throw up a very large number of matches which are not possible in reality.

Thus in a search profile, the possible values for the identities for the various loci may be as follows: D3, 15 or 16, 16 or 17; VWA 14 or 15, 14 or 15; D16 14 or 15, any value; D21 14 or 15 or 18, any value; THO 15 or 16, 15 or 16 or 17 or 18.

Such an approach allows a single set of results to be obtained, whilst taking into account within the search profiles the maximum amount of information available. It may be impossible to determine a known allele absolutely, but it still may be possible to say more than “no information” about it. As a result the success rate for samples where a profile is obtained, but cannot be expressed as a single result is increased.

The search tool can be used to make comparisons for a variety of purposes. Thus, referring to the values provided above, the following purposes may be under consideration:
1) The variation selected for loci D3 and VWA would be typical of that used to investigate a search profile which was thought to be a 2 person mixture. In such a case, a match might be made based on the specific identities for a locus independent of a match with the specific identities of another locus of that search profile, provided there was a match with the specific identities of the another locus in one of the search profiles. Thus a match would exist where D3 was 15,16 and VWA was 14,15 because this combination was envisaged with the ranges.
2) The variation selected for locus D16 is typical of that used to consider a parent child relationship between search and stored profile. Loci for which ambiguity is present often occur in such cases.

3) The variation selected for locus D21 is typical of that considered for the minor alleles in a major minor profile. In such cases, the minor alleles can often be deduced, but the deductions are ambiguous. Use of a wild card means that the match results have to be screened to see that the wildcard part of the match is viable given the observed profile.

4) The variation selected for THO is typical of the considerations involved for a three person mixture.

1. A method of searching a computer database containing a plurality of stored DNA profiles, the method comprising
generating a search profile, the search profile being formed of two or more allele identities for each of one or more loci, the allele identities having one of a value or a limited range of values or any value, wherein at least one of the allele identities has a limited range of values;
accessing one or more of the stored DNA profiles from the computer database, the stored DNA profiles having two or more allele identities for each of one or more loci, the allele identities having one of a value or a range of values or any value;
comparing, using a computer implemented method, the search profile against the one or more stored DNA profiles; establishing that the search profile matches a stored DNA profile when, in respect of a locus, the allele identities of the search profile correspond to or fall within the values for the allele identities for that locus of that stored DNA profile;
outputting a data set, the data set indicating those of the stored DNA profiles established as matching the search profile.

2. A method of searching a database containing a plurality of stored profiles, the method comprising
generating a search profile, the search profile being formed of two or more identities for each of one or more targets, the identities having one of a value or a range of values or any value, wherein at least one of the identities has a range of values;
accessing one or more of the stored profiles from the database, the stored profiles having two or more identities for each of one or more targets, the identities having one of a value or a range of values or any value; comparing the search profile against the one or more stored profiles;
establishing that the search profile matches a stored profile when, in respect of a target, the identities of the search profile correspond to or fall within the values for the identities for that target of that stored profile;
outputting a data set, the data set indicating those of the stored profiles established as matching the search profile.

3. The method of claim 2, wherein the database is a computer database and the method includes comparing, using a computer implemented method, the search profile against one or more stored profiles.

4. The method of claim wherein the stored profiles are stored DNA profiles.

5. The method of claim 2, in which the search profile identities are allele identities and/or the stored DNA profile identities are allele identities.

6. The method of claim 2, in which the search profile targets are loci and/or the stored DNA profile targets are loci.

7. The method of claim 1, in which the search profile comprises two or more alternative single profiles.

8. The method of claim 7 in which the alternative single profiles are separately compared against the one or more stored profiles.

9. The method of claim 7 in which the matches for a search profile which comprises two or more alternative single profiles are outputted as a single data set.

10. The method of claim 7, in which the presence of an identity which has a range of values within the search profile is provided by the two or more different values used for the identity between different single profiles.

11. The method of claim 1, in which the search profile is a single profile.

12. The method of claim 1, in Which the two or more identities for a target have the same or different values.

13. The method of claim 1, in which the value of one or more of the identities is an integer.

14. The method of claim 1, in which the value of all the identities is an integer.

15. The method of claim 1, in which the one or more identities having any value are provided by a wildcard function.

16. The method of claim 1, in which the value of one or more of the identities having a value or limited range of values is expressed in terms of an allele size.

17. The method of claim 1, in which the value of one or more of the identities having a value or limited range of values is expressed in terms of an allele designation.

18. The method of claim 17 in which the identities having a limited range of values have a range of 5 allele designations or less.

19. The method of claim 1, in which the method establishes that the search profile matches a stored DNA profile when, in respect of more than one locus, the allele identities of the search profile correspond to or fall within the values for the allele identities for those loci of that stored DNA profile.

20. The method of claim 1, in which the outputted data set provides a list of stored DNA profiles established as matching the search profiled

21. The method of claim 1, in which the outputted data set provides a ranked list, with the rank being provided according to a likelihood of the match.

22. The method of claim 1, in which the method includes using the outputted data set to indicate a person and/or item and/or location which was the source of a DNA profile matching the search profile.
